(19) United States
(12) Patent Application Publication
(10) Pub. No.: US 2018/0255757 A1
(43) Pub. Date: Sep. 13, 2018

(54) Retroreflective fishing line

(71) Applicant: Eric William Korman, Rochester, MN (US)

(72) Inventor: Eric William Korman, Rochester, MN (US)

(21) Appl. No.: 15/917,752

(22) Filed: Mar. 11, 2018

Related U.S. Application Data
(60) Provisional application No. 62/470,236, filed on Mar. 11, 2017.

(51) Int. Cl. A01K 91/00

(52) U.S. Cl. CPC A01K 91/00

(57) ABSTRACT

A retroreflective composite fiber product fishing line that offers increased visibility of the retroreflective composite fishing line in a low light environment to a fisherman by reflecting incident light applied to the retroreflective composite fishing line back toward the fisherman.

### BACKGROUND OF THE INVENTION

### 1. Field of the Invention

The present invention relates to a fishing line that incorporates a retroreflective fiber element the offers increased visibility in a low light environment to a fisherman by reflecting incident light applied to the retroreflective composite fishing line back to the fisherman.

### 2. Prior Art

By definition a retroreflective material is a material which when engaged by a beam of light will reflect the light approximately 180 degrees in an opposite direction to the applied incident light back toward the location of the light source. Retroreflective metallized spheres comprised of hemispherically aluminum-coated barium titanate glass beads are used to create retroreflective materials. The hemispheric aluminum coating creates the mechanism for retro-reflectivity since light passing through the clear half of the glass bead is reflected off the reflective aluminum-coated back, directing the light back toward the incident light source.

Conventional light returning reflective products exemplified by Tsunefuji Y. U.S. Pat. No. 5,804,275, and Wasserman A. U.S. Pat. No. 4,697,407 which reflect the light back to the source, formed into yarn-like products in which spherical beads or triangular pyramid shaped prisms are formed consecutively and regularly in the material, composed of polyester or vinyl chloride, which reflect incident light back to the direction of incidence of light are available.

With conventional yarn-like light returning reflective products, spherical beads or pyramid shaped prisms are formed consecutively and regularly in the material, such as polyester and vinyl chloride to form a woven fabric for safety applications at night.

However, the above-mentioned conventional light returning reflective products are formed into a yarn with natural fibers or synthetic fibers such as polyester that lack the tensile strength necessary to be used as a fishing line. Therefore, they can be used in woven fabric material, which results in the material being useful for a wide variety of applications, yet is limited to the extent in that it does not include use as a retroreflective fishing line.

Meanwhile, existing conventional braided fishing lines comprised of ultrahigh molecular weight, high tenacity yarn (also referred to as “fiber”) based on spun polyolefins are described in numerous patents, published patent applications, and technical articles. Exemplary references include Kavesh et al. U.S. Pat. No. 4,413,110; Smith et al. U.S. Pat. No. 4,344,908; Smith et al. U.S. Pat. No. 4,422,993; Kavesh et al. U.S. Pat. No. 4,356,138; Harpell et al. U.S. Pat. No. 4,455,273; Kavesh et al, U.S. Pat. No. 4,897,902; Neal U.S. Pat. No. 5,277,858; and Kirkland et al. WO 94/00627.

The filaments of these yarns are generally made from linear polyethylene or polypropylene chains of a molecular weight of at least 400,000, a tenacity of at least 15 g/denier, a tensile modulus of at least 500 g/denier, a melting point of at least 140° C., have high abrasion resistance, low stretch, high toughness, good dimensional and hydrolytic stability, and high resistance to creep under sustained loads. The yarns made from the filaments are opaque and white in appearance.

This spun ultrahigh molecular weight; high tenacity yarn can be used to make braided fishing lines exhibiting low stretch as well as high toughness. These fishing lines can be dyed to create colors desirable for their ability to blend into a natural background or to increase the visibility of the fishing line to the fisherman in hi-visibility manifestations in the daylight; however, even the brightest of these colors loses its visibility in low light conditions.

Existing fishing lines comprised of ultrahigh molecular weight, high tenacity yarn lack visibility in the dark; therefore, it is difficult for a fisherman to see where their line position is in relation to their surroundings which leads to confusion and tangled fishing lines. Likewise, it is difficult for fishermen to detect when a fish bites their hook if the fishing line is not visible in the dark. At present, the existing prior art doesn't recognize the advantage of reflectivity as a means to increase the visibility of a fishing line in the dark.

In light of such a missing tool for today's fishermen, a braided fishing line that incorporates a retroreflective element so that incident light shined or applied upon the fishing line is reflected back toward the light source that would allow a fisherman to easily see the entire length of the fishing line in low light conditions would be advantageous.

### BRIEF SUMMARY OF THE INVENTION

Having been developed in consideration of the above-stated situation, this invention intends to solve these conventional problems, offering a fishing line composed of ultrahigh molecular weight, high tenacity polyolefin yarn that incorporates a novel retroreflective element to make an unexpectedly visible fishing line in the dark when an incident light is directed, shined, or applied upon the invention.

The product of reference is summed up as a retroreflective composite fiber product fishing line a retroreflective fiber element, and; a synthetic fiber element; wherein each of said retroreflective fiber element offers increased visibility of the retroreflective composite fishing line in a low light environment to a fisherman by reflecting incident light applied to the retroreflective composite fishing line back to the fisherman; wherein each of said retroreflective fiber element and each of said synthetic fiber element are formed into a composite line or string used for fishing that increases the visibility of the retroreflective composite fiber product fishing line to a fisherman in a low light environment.

### BRIEF DESCRIPTION OF THE DRAWINGS

FIG. 1 is an enlarged drawing of an extracted side view of a retroreflective fiber with 2 flat surfaces comprised of a plurality of consecutively disposed light-reflecting spherical glass beads (3) consecutively disposed on a flat polyester fiber (4). Incident light enters the light-reflecting spherical glass beads (1) attached to the flat polyester fiber (4) and the rounded surface of the bead causes the light ray to bend downward to a point below where the bead is embedded in the polyester fiber. Light striking the metalized back of the embedded portion of the bead is reflected back to the path of entry in the direction approximately opposite of the direction of the incident light (2) to increase the visibility of the fishing line to the user.

FIG. 2A is an enlarged drawing showing how the retroreflective element (10.) described in FIG. 1 is braided with 1 or more synthetic fiber elements comprised of spun ultrahigh molecular weight, high tenacity yarn (11) to form a braided retroreflective composite fiber product fishing line

FIG. 2B is an expanded view of the retroreflective fiber (10) described in FIG. 1.

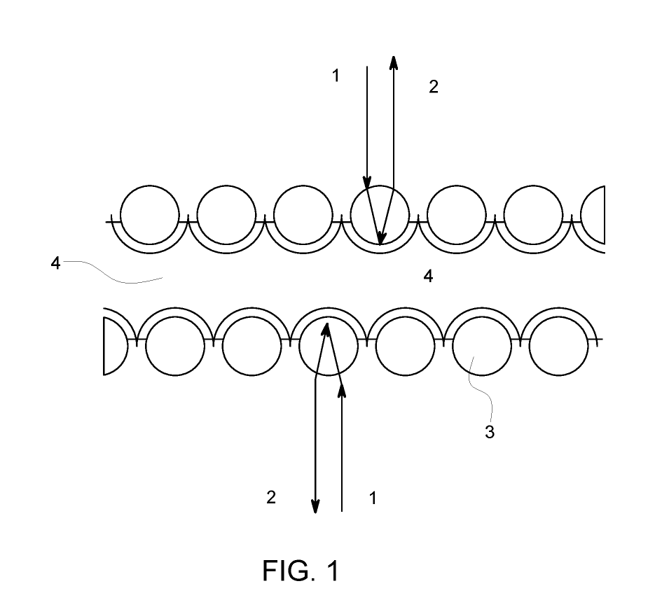

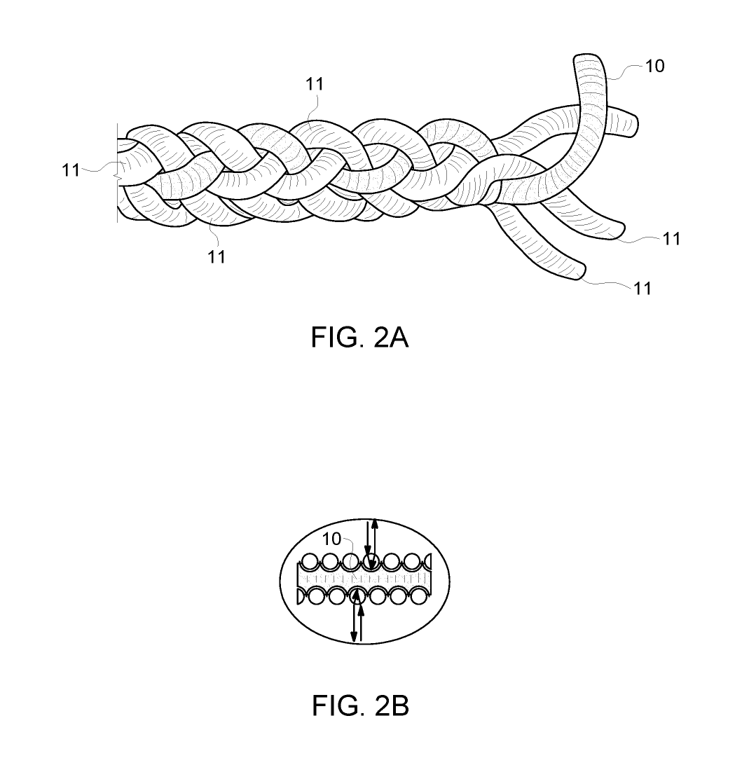

### DETAILED DESCRIPTION OF THE INVENTION

The fiber product having reflective elements of this invention consists at a minimum of 1 retroreflective fiber, made of polyester or other synthetic material receptive to the disposition of light-reflecting hemispheric metalized spherical glass beads or pyramid shaped prisms on one or more flat surface of the retroreflective fiber, comprised by a plurality of consecutively disposed light-reflecting hemispheric metalized spherical glass beads or pyramid shaped prisms. The light-reflecting hemispheric metalized spherical glass beads or pyramid shaped prisms collect and focus incident light from various light sources and reflect it back 160 to 200 degrees approximately in the opposite direction of the incidence of light shined or applied to the invention. This retroreflective fiber is comprised of material with a lower tensile strength that traditional high tenacity ultrahigh molecular weight yarn based on spun polyolefins and therefore were not before seen by the fishing line manufacturers as suitable for inclusion in previous or current fishing line manifestations.

The fiber product having reflective elements is braided together using a multi-bobbin braiding apparatus with 1 or more synthetic fibers comprised of spun ultrahigh molecular weight, high tenacity yarn to form a long, high tenacity, retroreflective fishing line that Is more visible under low light conditions when incident light source is shined or applied to the retroreflective composite fiber product fishing line than existing manifestations of high visibility fishing line.

The product of reference is summed up as a retroreflective fiber product fishing line comprising at minimum: a synthetic ultrahigh molecular weight, high tenacity fiber element; a retroreflective fiber element; wherein each of said retroreflective elements is comprised of a plurality of consecutively disposed light-reflecting spherical glass beads or pyramid prisms; wherein each of said light-reflecting spherical micro spherical glass beads or pyramid shaped prisms offers increased visibility of the retroreflective composite fishing line in a low light environment to a fisherman by reflecting incident light applied to the retroreflective composite fishing line back to the fisherman; wherein the said retroreflective fiber element and synthetic fiber element are braided, twisted, entangled, or fused into a line or string used for fishing.

The novel retroreflective fishing line maintains many of the benefits of existing fishing lines comprised of spun ultrahigh molecular weight, high tenacity yarn while creating the advantage of increased visibility in low light conditions when an incident light source is shined or applied to the retroreflective composite fiber product fishing line that was never previously available to fishermen. The novel retroreflective fishing line allows fishermen to vastly increase their success through more accurate positioning of their lines and detection of bites in low light conditions.

What is claimed is:

1. A retroreflective composite fiber product fishing line, comprising: a retroreflective fiber element, and; a synthetic fiber element; wherein said retroreflective fiber element offers increased visibility of the retroreflective composite fishing line in a low light environment by reflecting incident light shined toward or applied to the retroreflective composite fishing line back in a direction toward a fisherman that shines or applies the light; wherein said retroreflective fiber elements and said synthetic fiber elements are formed into a composite line or string used for fishing.

2. A retroreflective composite fiber product fishing line as recited in claim 1, wherein the retroreflective fiber element is composed of at least 1 flat surface.

3. A retroreflective composite fiber product fishing line as recited in claim 1, wherein said retroreflective fiber element is comprised of at least one flat surface composed of a plurality of consecutively disposed light-reflecting hemispheric metalized spherical glass beads or metalized pyramid shaped prisms.

4. A retroreflective composite fiber product fishing line as recited in claim 1, wherein said retroreflective fiber element is comprised of a plurality of consecutively disposed light-reflecting hemispherically aluminum-coated barium titanate glass beads or pyramid shaped prisms.

5. A retroreflective composite fiber product fishing line as recited in claim 1, wherein said retroreflective fiber element has at least one flat surface comprised of a plurality of consecutively disposed light-reflecting hemispheric metalized spherical glass beads or pyramid shaped prisms that reflect light 160 to 200 degrees in a direction approximately opposite to the direction of incident light applied to the invention.

6. A retroreflective composite fiber product fishing line as recited in claim 1, wherein the retroreflective composite fishing line is comprised of 1 to 8 synthetic fiber element strands.

7. A retroreflective composite fiber product fishing line as recited in claim 1, wherein the retroreflective composite fishing line is comprised of 1 to 8 retroreflective fiber element strands.

8. A retroreflective composite fiber product fishing line as recited in claim 1, wherein each of said synthetic fiber element is comprised of yarn composed of ultrahigh molecular weight, high tenacity, polyolefin filaments.

9. A retroreflective composite fiber product fishing line as recited in claim 1, wherein each of said synthetic fiber element is comprised of Spectra, Dyneema, Dacron, Nylon, Polyvinylidene fluoride, or other high tensile strength synthetic fiber.

10. A retroreflective composite fiber product fishing line as recited in claim 1, wherein the synthetic fiber element exhibits a tenacity of at least 15 gram per denier and a tensile modulus of at least 500 gram per denier.

11. A retroreflective composite fiber product fishing line as recited in claim 1, wherein each of said synthetic fiber element, and each of said reflective fiber element are braided, twisted, entangled, or fused together to form a retroreflective composite fiber product fishing line.

12. A retroreflective composite fiber product fishing line as recited in claim 1, wherein said retroreflective composite fiber product fishing line product has a breaking strength from 1 to 250 pounds of pressure.

13. A retroreflective composite fiber product fishing line as recited in claim 1, wherein said retroreflective composite fiber product fishing line product has a diameter less than 1.5 millimeters.

14. A process for increasing the visibility of a retroreflective composite fiber product fishing line to a fisherman in a low light environment, comprising the steps of; providing at first a minimum of a retroreflective fiber element, and a synthetic fiber element, optionally braiding, twisting, entangling, or fusing the fiber elements together to form a retroreflective composite fiber product fishing line.

15. A process for increasing the visibility of a retroreflective composite fiber product fishing line to a fisherman in a low light environment as recited in claim 14, wherein the retroreflective fiber element is composed of: at least 1 flat surface comprised of a plurality of consecutively disposed light-reflecting hemispheric metalized spherical glass beads or pyramid shaped prisms that reflect light 160 to 200 degrees in a direction approximately opposite to the direction of incident light applied to the invention.
